(19) United States
(12) Patent Application Publication
(10) Pub. No.: US 2014/0019407 A1
(43) Pub. Date: Jan. 16, 2014

(54) SYSTEMS AND METHODS WITH CLIENT ADVISORIES IN AN ON-DEMAND COMPUTING ENVIRONMENT

(71) Applicant: salesforce.com, inc., San Francisco, CA (US)

(72) Inventor: Daniel Wong, San Francisco, CA (US)

(21) Appl. No.: 13/938,950

(22) Filed: Jul. 10, 2013

Related U.S. Application Data
(60) Provisional application No. 61/670,207, filed on Jul. 11, 2012.
(60) Provisional application No. 61/670,211, filed on Jul. 11, 2012.

(51) Int. Cl. G06F 17/30

(52) U.S. Cl. CPC G06F 17/30289
USPC 707/609

(57) ABSTRACT

A database system is provided for managing protected data resources. The database system includes a database configured to store protected data resources for a client; a resource module coupled to the database to manage the protected data resources; and an advisory module coupled to the database. The advisory module is configured to scan the protected data resources and to generate an advisory associated with the protected data resources.

### CROSS-REFERENCE TO RELATED APPLICATION

This application claims the benefit of U.S. provisional patent application Ser. No. 61/670,207, filed Jul. 11, 2012 and U.S. provisional patent application Ser. No. 61/670,211 filed Jul. 11, 2012. Each of these applications is hereby incorporated by reference in its entirety.

### TECHNICAL FIELD

Embodiments of the subject matter described herein generally relate to an on-demand computing environment, such as a multi-tenant database system. More particularly, exemplary embodiments relate to systems and methods for generating and administrating client advisories in an on-demand computing environment.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. The multi-tenant platform operator may make improvements to the platform based upon collective information from the entire tenant community, as well as improving collaboration and integration between applications and the data managed by the various applications. The multi-tenant architecture therefore allows convenient and cost effective sharing of similar application features between multiple sets of users. However, with a large number of users, a wide variety of issues may arise. Recognizing new product offerings and/or current inefficiencies within the system may be difficult for the organizations and tenants.

Accordingly, it is desirable to provide systems and methods for administrating client advisories in an on-demand environment. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary system for the storage, management, and administration of protected data resources in accordance with an exemplary embodiment;

FIG. 2 is a block diagram of an advisory module of the system of FIG. 1 in accordance with an exemplary embodiment;

FIG. 3 is a flow chart that illustrates a process for generating client advisories in a database system in accordance with an exemplary embodiment; and

FIG. 4 is a block diagram of an exemplary multi-tenant data processing environment associated with the system of FIG. 1 and the method of FIG. 3 in accordance with an exemplary embodiment.

### DETAILED DESCRIPTION

Broadly, exemplary embodiments discussed herein provide improved systems and methods for the generation and administration of client advisories in an on-demand environment. In one exemplary embodiment, a server system includes a resource module and an advisory module. The resource module manages protected data resources of clients stored in a database. The advisory module monitors the activity of the clients with respect to the resource module and database, and in response, generates and administers client advisories. The client advisories may be, for example, recommendations for improving the customer experience, such as suggestions to improve application performance and/or automatic equipment or services procurement.

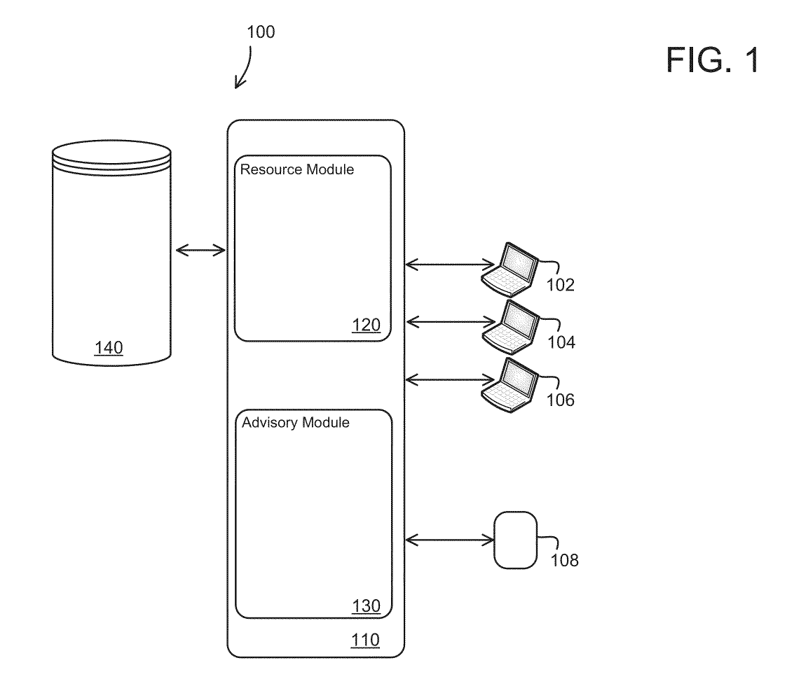

FIG. 1 is a diagram that illustrates an exemplary environment associated with the storage, management, and administration of protected data resources. In particular, FIG. 1 depicts a simplified database system 100 having a server system 110 with a resource module 120 and an advisory module 130, and the system 100 may be a database system that includes a database 140. These functional components of the system 100 are operatively associated with one another, and may be coupled together using any suitable interconnection arrangement or architecture that accommodates data communication as needed.

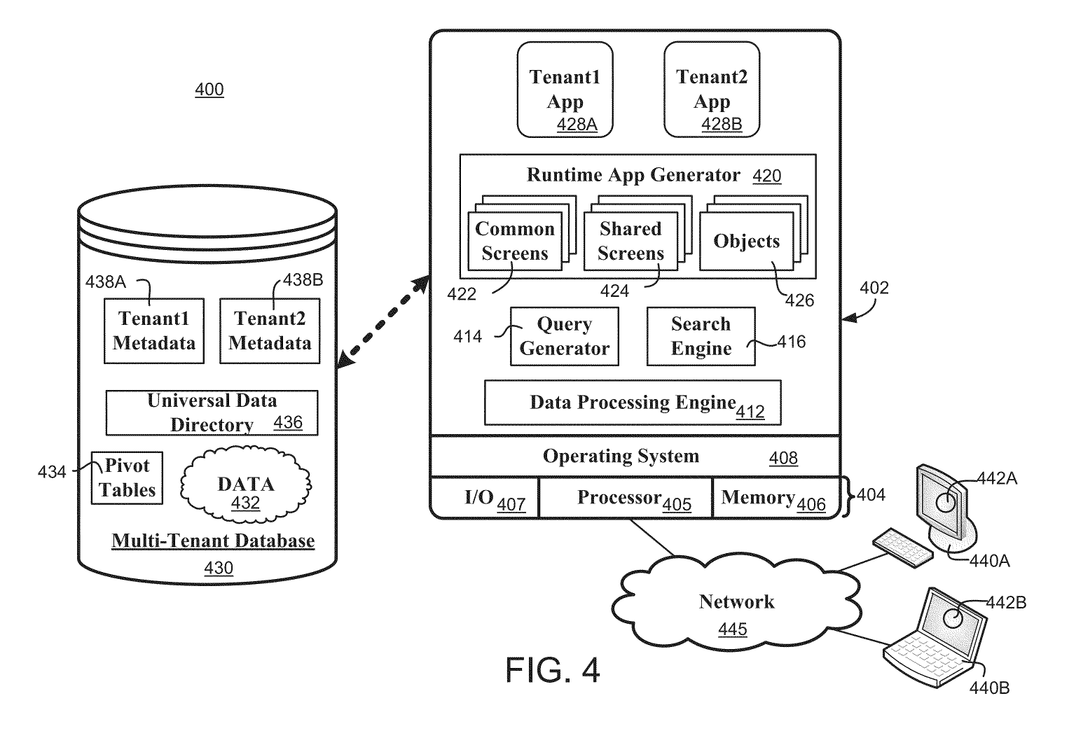

In general, and as discussed in greater detail below, the server system 110 functions as an interface and/or processing engine to store, manage, and administer the protected data resources in the database 140. The database 140 may be any sort of repository or other data storage system capable of storing the data resources associated with any number of users. Although not depicted in FIG. 1, the system 100 may be deployed in the context of a multi-tenant application system, such as a system described below with reference to FIG. 4.

The system 100 includes or otherwise interacts with a number of devices or systems 102, 104, 106, 108. In the depicted embodiment, the devices or systems include an administrator device 102; client devices 104, 106; and procurement system 108. The roles of such devices and systems 102, 104, 106, 108 may vary and/or be combined with one another, but one exemplary scenario will be described. Generally, the administrator device 102 is associated with the owner or host of the system 100 that hosts applications and other types of data resources for one or more clients. In general, the client may refer to the organization that owns or otherwise manages the protected data resources on behalf of a group, employees or users. In some embodiments, the client may be a tenant, as described in greater detail below. As such, in the depicted embodiment, the first client device 104 represents an organization or internal organization administrator, and second client (or user) device 106 represents a customer, user, or employee associated with the organization. The procurement system 108 may be associated with a third-party procurement agent that functions to provide assistance with respect to issues and solutions associated with the system 100, as discussed below. For example, the procurement system 108 may interact with a vendor or distributor of products associated with a client issue. In one exemplary embodiment, the procurement system 108 functions as an interface for a business to business provider or service that enables the advisory module 130 to purchase equipment and services, solicit bids for equipment and services, and/or offer any other third-party solutions to the client. Additional functions are described below.

Although FIG. 1 depicts a single device or system 102, 104, 106, 108 for each type, the system 100 may support a number of such devices or systems 102, 104, 106, 108, as well as other types of devices and users. For the sake of simplicity, however, the remainder of this description focuses on only set of users. In practice, the devices 102, 104, 106 may be any sort of system, personal computer, mobile telephone, tablet or other network-enabled user device on a network for accessing the system 100, while the system 108 may be any suitable interface, system, or service that interacts with the system 100 for procurement.

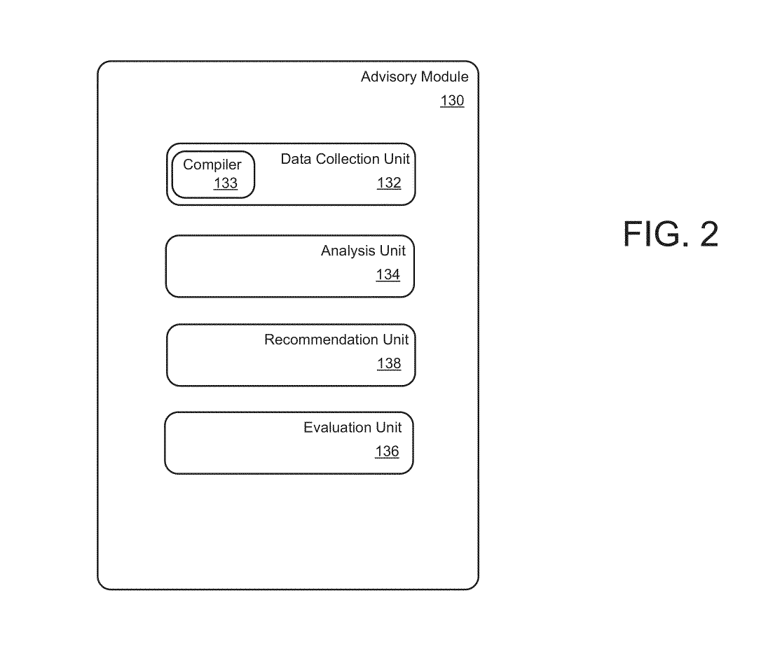

FIG. 1 depicts functional units that might be realized using, for example, one or more processors, a data processing engine, or other computer-implemented logic resident in the system 100. In this regard, the server system 110, including the resource module 120 and the advisory module 130, may represent, without limitation: a piece of hardware (such as a computer, a mobile electronic device, or any processor-based computing device); a functional, logical, or processing module of a piece of hardware; a software-based application that executes at a piece of hardware; or the like. In certain embodiments, the units may be realized as one more web-based applications, desktop applications, object-oriented scripts running on webpages, or the like, which are suitably designed to perform the various client module tasks, processes, and procedures described in more detail herein. FIG. 1 depicts only one set of resource and advisory modules 120, 130 in the system 100. In practice, however, a number of such modules 120, 130 may be present in the system 100. Moreover, although the resource module 120 and the advisory module 130 are depicted as distinct elements, the two could be realized as a single logical element, module, or hardware device. A general description of the resource module 120 and the advisory module 130 will be briefly provided prior to a more detailed description with reference to FIGS. 2-4.

In general, the resource module 120 is suitably designed to manage the protected data resources stored in the database 140. The devices 102, 104, 106 particularly the user device 106, may attempt to access the protected data resources in the database 140 via the resource module 120. As examples, the resource module 120 may function to manage access to the protected data resources in the resource server 120, for example, by authenticating users, formatting data requests, retrieving the data from the database 140, and presenting the data to the client (e.g., via client devices 104, 106), as requested by the user and/or authorized by the organization.

In general, the advisory module 130 is suitably designed to monitor the activity of the users and/or the organization associated with the user with respect to the resource module 120 and/or the database 140. For example, the advisory module 130 may collect data concerning data requests, data results, problems or issues reported by the user to the resource module 120, hardware and software attributes, and the like. In one exemplary embodiment and as discussed in greater detail below, the advisory module 130 may scan the client data and generate a scan record that contains the details or summary of the scan. The term “scan record” may also be referred to as an issue, a client profile, a scan profile, a client pattern, and/or client findings. Moreover, the advisory module 130 may evaluate broader trends across the scan records of multiple clients. In response to these scan records, the advisory module 130 may generate recommendations for the client, e.g., via client device 104. Such recommendations may include advisories (or messages) providing information about the issue and/or solution, new services or products, and vendor recommendations. Additionally, in some embodiments, the advisory module 130 may take steps to remedy the issue, such as automatic equipment procurement or bid solicitation. Additional details about the advisory module 130 are provided below. The advisories may be presented directly to the user via the client device 104, to the system administrator via the administrator device 102, and/or to the procurement system 108.

FIG. 2 is a block diagram of the advisory module 130. The general function of the advisory module 130 is discussed above. Additional details of the advisory module 130 will be discussed below with reference to FIGS. 1 and 2. As shown in FIG. 2, the advisory module 130 includes a number of functional unit (or sub-modules) 132, 134, 136, 138 configured to perform the specific functions described below. In practice, the various units may be integrated with one another.

In accordance with an exemplary embodiment, the advisory module 130 includes a data collection unit 132, a client analysis unit 134, an evaluation unit 136, and a recommendation unit 138. The data collection unit 132 is configured to collect information about the client, including client attributes and activities. For example, the data collection unit 132 may monitor the data requests between the user (e.g., between user device 106) and the resource module 120 to determine usage characteristics, resource characteristics, and/or deployment characteristics. The data collection unit 132 may monitor the data for a particular issue, as discussed below, or continuously monitor the data for a group of issues. In some exemplary embodiments, the data collection unit 132 may collect information by scanning the source code of client applications, for example, with a compiler 133 to determine patterns and operations associated with the applications. Such compilers 133 may provide quantifiable characteristics of the applications with code analysis and run time profiling. As noted below, the patterns identified by the compiler 133 may include, for example, the level of mathematical operations, encryptions, and/or program inefficiencies and bugs.

The data collection unit 132 may also track the equipment or inventory of the client, such as equipment manufacturer, model, date of deployment, status, health, and issues. Moreover, the data collection unit 132 may collect information associated with issues that the user may be having with the system 100, for example, by scanning the appropriate fields in troubleshooting tickets and resolutions and/or tables in help applications.

The analysis unit 134 may aggregate and categorize this information into a scan record associated with the client. The scan record may include information about a particular client application that has been scanned and/or about multiple client applications.

In some exemplary embodiment, the scan record may include or otherwise be considered with a client profile with user preferences regarding the advisory module 130. The user preferences may include, for example, permission to scan data, preferred vendors, procurement preferences, purchase or price limits, and/or communication preferences.

The evaluation unit 136 is configured to evaluate the information in the scan record. In particular, the evaluation unit 136 may compare aspects of the scan record to predetermined issue profiles. The issue profiles may refer to a set of conditions or patterns that indicates a problem, issue, inefficiency, and/or potential improvements. In some cases, the issue profiles may be associated with an identified problem, e.g., a greater than anticipated processing time or inadequate equipment. In other cases, the issues profiles may be associated with a new or existing service provided by the host that may be beneficial to the client, depending on the scan record. In still further embodiments, the issue profile may be generated based on a pattern or trend of issues from other clients. Based on the issue profile and scan record, the evaluation unit 136 may generate one or more findings associated with the client. The term “finding” refers to the identified issues, problems, improvements, and/or recommendations associated with the evaluated client data.

The recommendation unit 138 may receive the findings from by the evaluation unit 136 and generate an advisory (or recommendation) associated with each individual finding or combination of findings. In one exemplary embodiment, the recommendation unit 138 may map a finding or combination of findings to an advisory or group of advisories. The advisory of the recommendation unit 138 may depend on a number of factors, including the nature of the finding and client preferences. In further cases, the advisory of the recommendation unit 138 may be based on the collective data of the respective client and other clients, such as general trends and patterns. In some embodiments, the recommendation unit 138 may model or “bucket test” advisory strategies without client involvement to determine the associated benefit.

In one exemplary embodiment, the scan used to generate the scan record, the issue profile used by the evaluation unit 136, and associated recommendation from by the recommendation unit 138 may be provided by a vendor or procurement agent (e.g., via procurement system 108) that generally provides a description and/or test to recognize the finding, a proposed recommendation for the finding, and the associated benefits.

The advisory generated in the recommendation unit 138 may take a number of forms. For example, the recommendation unit 138 may issue an information advisory presented to the user via the client device 104 that outlines the finding and suggested recommendation. As another example, the recommendation unit 138 may provide a sales advisory that details the issue and a product that may address the finding. In further embodiments, the recommendation unit 138 may provide a vendor recommendation to the user via the client device 104.

In other embodiments, the recommendation unit 138 may generate advisories that initiate actions with third parties, such as procurement system 108. For example, the recommendation unit 138 may generate bid solicitations for procurement system 108 to propose remedies associated with the findings. As another example, the recommendation unit 138 may generate orders for the procurement system 108 to automatically effectuate the advisory, including for example, ordering the recommended equipment or service. In some instances, the recommendation unit 138 may generate a message for the procurement system 108 to proactively contact the client to correct or remediate an issue. The procurement system 108 may be a vendor system that provides recommended products or services and/or a third-party that facilitates such transactions, such as an online auction system that solicits bids for replacement hardware.

In one exemplary embodiment, the procurement system 108 may include application programming interface (API) or widget provided by the vendor or procurement agent. The API may enable the procurement system 108 to interact with the recommendation unit 138 and other components of the advisory module 130. In one exemplary embodiment, the API may provide a scan that generates an appropriate scan record, an issue profile, and associated recommendation for use by the recommendation unit 138, as discussed above.

Accordingly, based on user activity or user characteristics, the advisory module 130 may automatically collect, analyze, and evaluate client issues and provide recommendations associated with the findings. Some particular examples may be provided below.

As an example, the administrator or host of the database system 100 may be offering a new feature, such as a separate organizational wide default table feature that provides default access to certain groups within the client. In such a scenario, the data collection unit 132 may collect data related to the deployment and access characteristics of the client; the analysis unit 134 may incorporate such information into the scan record; and the evaluation unit 136 may evaluate if and how the client would benefit from the separate organizational wide default table, given the deployment and access characteristics. As an example, the issue profile may include conditions such as the client is not currently implementing separate organizational wide default table and is encountering delays in access evaluation and/or queries. Based on these conditions, the evaluation unit 136 may recognize that the separate organizational wide default table would improve efficiency in responding to client queries. If applicable, the recommendation unit 138 may issue an advisory message to the client advising the client of the availability, cost, and benefit of the organizational wide default table feature.

As another example, the database system 100 may host a particular type of application for the user, such as an APEX™ application. In such a scenario, the data collection unit 132 may collect data related to code and run-time profiling associated with the application, and the analysis unit 134 may incorporate such information into the scan record. Furthermore, the evaluation unit 136 may evaluate information to identify, for example, a high level of statistical calculation and a corresponding deficiency in resources. Moreover, the evaluation unit 136 may determine if and how the client would benefit from additional resources, such as an additional statistics library. Finally, the recommendation unit 138 may issue an advisory message to the client advising the client of the availability, cost, and benefit of the statistics library.

As a further example, the database system 100 may host a trouble-shooting system for a client. In such a scenario, the data collection unit 132 may collect the data related to tickets submitted by the client or users associated with the client. Such tickets may be logged and categorized by the analysis unit 134 for incorporation into the scan record. The evaluation unit 136 may analyze the tickets, for example, by subcategorizing the tickets to determine if a source of the issue may be identified. For example, an issue profile may indicate that a brand or model of hardware in the client system may be having issues. In some situations, such as this scenario, the issue profile may include information from other clients, such as trends associated with a brand or model of hardware. These trends may identify previously unrecognized patterns or problems with client equipment or services. Based on this information, the evaluation unit 136 may determine if and how the client would benefit from additional resources, such new hardware. Finally, the recommendation unit 138 may issue an advisory message to the client advising the client of the availability, cost, and benefit of the additional hardware. Other advisories may include a request to the procurement system 108 for bids or quotes on additional hardware.

As a further example, the administrator or host of the database system 100 may be offering encryption and/or debugging services. In such a scenario, the data collection unit 132 may collect data related to the client applications, for example, by analyzing the source code of the client applications. The analysis unit 134 may incorporate such information into the scan record, and the evaluation unit 136 may evaluate if and how the client would benefit from the encryption and/or debugging services. If applicable, the recommendation unit 138 may issue an advisory message to the client advising the client of the availability, cost, and benefit of the services.

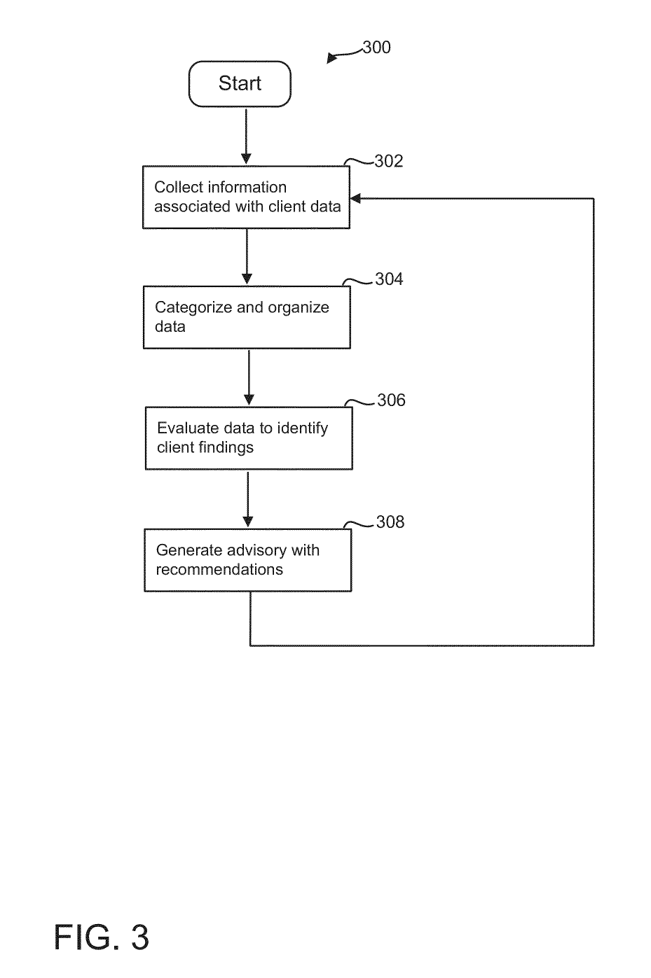

FIG. 3 is a flow chart that illustrates an exemplary embodiment of a database advisory process 300. The various tasks performed in connection with the process 300 may be performed by software, hardware, firmware, or any combination thereof. For illustrative purposes, the following description of the process 300 may refer to elements mentioned above in connection with FIGS. 1 and 2. As such, FIGS. 1-3 are referenced below.

It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The process 300 assumes that the client device(s) 104, 106 manages or accesses to protected data resources stored in the database 140. To this end, the client device 102 may generate and send a suitable formatted populated queries and transactions to the resource module 120. In step 302, the data collection unit 132 of the advisory module 130 collects information associated with the client interaction and/or client data stored in the database 140. As noted above, the information may be collected by scanning the client data. In step 304, the analysis unit 134 categorizes and organizes the data into a scan record. In step 306, the evaluation unit 136 evaluates the data to identify client findings. As noted above, the scan record may be compared to an issue profile to identify the client findings. In a step 308, the recommendation unit 138 generates a recommendation based on the client findings in the form of advisory messages to address, remedy, and/or improve the issue.

In some exemplary embodiments, the systems and methods described above may be implemented in a multi-tenant application system, such as the multi-tenant application system 400 illustrated in FIG. 4. Referring to FIG. 4, an exemplary multi-tenant application system 400 suitably includes a server 402 that dynamically creates virtual applications 428A-B based upon data 432 from a common database 430 that is shared between multiple tenants. As an example, the database 430 may store the protected data resources discussed above. Data and services generated by the virtual applications 428A-B are provided via network 445 to any number of client devices 440A-B, as desired. Each virtual application 428A-B is suitably generated at run-time using a common platform 410 that securely provides access to data 432 in database 430 for each of the various tenants subscribing to system 400. As examples, the virtual applications 428A-B may correspond to one or more of the modules 120, 130 discussed above, and devices 440A-B may correspond to one or more of the devices or systems 102, 104, 106, 108 discussed above.

A “tenant” or “organization” generally refers to a group of users that shares access to common data within database 430. Tenants may represent customers, customer departments, business or legal organizations, and/or any other entities that maintain data for particular sets of users within system 400. Using the examples above, a tenant may be a group that enables end users to access protected data resources via a client module. Although multiple tenants may share access to a common server 402 and database 430, the particular data and services provided from server 402 to each tenant can be securely isolated from those provided to other tenants, as described more fully below. The multi-tenant architecture therefore allows different sets of users to share functionality without necessarily sharing each other's data 432.

Database 430 is any sort of repository or other data storage system capable of storing and managing data 432 associated with any number of tenants. Database 430 may be implemented using any type of conventional database server hardware. In various embodiments, database 430 shares processing hardware 404 with server 402. In other embodiments, database 430 is implemented using separate physical and/or virtual database server hardware that communicates with server 402 to perform the various functions described herein.

Data 432 may be organized and formatted in any manner to support multi-tenant application platform 410. In various embodiments, data 432 is suitably organized into a relatively small number of large data tables to maintain a semi-amorphous “heap”-type format. Data 432 can then be organized as needed for a particular virtual application 428A-B. In various embodiments, conventional data relationships are established using any number of pivot tables 434 that establish indexing, uniqueness, relationships between entities, and/or other aspects of conventional database organization as desired.

Further data manipulation and report formatting is generally performed at run-time using a variety of meta-data constructs. Metadata within a universal data directory (UDD) 436, for example, can be used to describe any number of forms, reports, workflows, user access privileges, business logic and other constructs that are common to multiple tenants. Tenant-specific formatting, functions and other constructs may be maintained as tenant-specific metadata 438A-B for each tenant, as desired. Rather than forcing data 432 into an inflexible global structure that is common to all tenants and applications, then, database 430 is organized to be relatively amorphous, with tables 434 and metadata 436-438 providing additional structure on an as-needed basis. To that end, application platform 410 suitably uses tables 434 and/or metadata 436, 438 to generate “virtual” components of applications 428A-B to logically obtain, process, and present the relatively amorphous data 432 from database 430.

Server 402 is implemented using one or more actual and/or virtual computing systems that collectively provide a dynamic application platform 410 for generating virtual applications 428A-B. Server 402 operates with any sort of conventional computing hardware 404, such as any processor 405, memory 406, input/output features 407 and the like. Processor 405 may be implemented using one or more of microprocessors, microcontrol modules, processing cores and/or other computing resources spread across any number of distributed or integrated systems, including any number of “cloud-based” or other virtual systems. Memory 406 represents any non-transitory short or long term storage capable of storing programming instructions for execution on processor 405, including any sort of random access memory (RAM), read only memory (ROM), flash memory, magnetic or optical mass storage, and/or the like. Input/output features 407 represent conventional interfaces to networks (e.g., to network 445, or any other local area, wide area or other network), mass storage, display devices, data entry devices and/or the like. In a typical embodiment, application platform 410 gains access to processing resources, communications interfaces and other features of hardware 404 using any sort of conventional or proprietary operating system 408. As noted above, server 402 may be implemented using a cluster of actual and/or virtual servers operating in conjunction with each other, typically in association with conventional network communications, cluster management, load balancing and other features as appropriate.

Application platform 410 is any sort of software application or other data processing engine that generates virtual applications 428A-B that provide data and/or services to client devices 440A-B. Virtual applications 428A-B are typically generated at run-time in response to queries received from client devices 440A-B, as described more fully below. In the example illustrated in FIG. 4, application platform 410 includes a bulk data processing engine 412, a query generator 414, a search engine 416 that provides text indexing and other search functionality, and a runtime application generator 420. Each of these features may be implemented as a separate process or other module, and many equivalent embodiments could include different and/or additional features, components or other modules as desired.

Runtime application generator 420 dynamically builds and executes virtual applications 428A-B in response to specific requests received from client devices 440A-B. Virtual applications 428A-B created by tenants are typically constructed in accordance with tenant-specific metadata 438, which describes the particular tables, reports, interfaces and/or other features of the particular application. In various embodiments, each virtual application 428A-B generates dynamic web content that can be served to a browser or other client program 442A-B associated with client device 440A-B, as appropriate. Data processing engine 412 performs bulk processing operations on data 432 such as uploads or downloads, updates, online transaction processing and/or the like.

In operation, then, developers use application platform 410 to create data-driven virtual applications 428A-B for the tenants that they support. Such applications 428A-B may make use of interface features such as tenant-specific screens 424, universal screens 422 or the like. Any number of tenant-specific and/or universal objects 426 may also be available for integration into tenant-developed applications 428A-B. Data 432 associated with each application 428A-B is provided to database 430, as appropriate, and stored until requested, along with metadata 438 that describes the particular features (e.g., reports, tables, functions, etc.) of tenant-specific application 428A-B until needed.

Data and services provided by server 402 can be retrieved using any sort of personal computer, mobile telephone, tablet or other network-enabled client device 440 on network 445. Typically, the user operates a conventional browser or other client program 442 to contact server 402 via network 445 using, for example, the hypertext transport protocol (HTTP) or the like. The user typically authenticates his or her identity to the server 402 to obtain a session identification (“SessionlD”) that identifies the user in subsequent communications with server 402. When the identified user requests access to a virtual application 428, application generator 420 suitably creates the application at run time based upon metadata 436 and 438, as appropriate. Query generator 414 suitably obtains the requested data 432 from database 430 as needed to populate the tables, reports or other features of virtual application 428. As noted above, the virtual application 428 may contain Java, ActiveX or other content that can be presented using conventional client software 442 running on client device 440; other embodiments may simply provide dynamic web or other content that can be presented and viewed by the user, as desired

Generally speaking, the various functions and features described above may be carried out with any sort of hardware, software and/or firmware logic that is stored and/or executed on any platform. Some or all aspects of exemplary embodiments may be carried out, for example, by logic executing within platform 410 in FIG. 4, for example, using software or firmware logic that is stored in memory and executed by processor as part of application platform. The particular hardware, software and/or firmware logic may vary from context to context, implementation to implementation, and embodiment to embodiment in accordance with the various features, structures and environments set forth herein. The particular means used to implement each of the various functions may be any sort of processing structures that are capable of executing software and/or firmware logic in any format, and/or any sort of application-specific or general purpose hardware, including any sort of discrete and/or integrated circuitry.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIGS. 1-4 depicts exemplary arrangements of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A database system, comprising:
a database configured to store protected data resources for a client;
a resource module coupled to the database to manage the protected data resources; and
an advisory module coupled to the database, the advisory module configured to scan the protected data resources and to generate an advisory associated with the protected data resources.

2. The database system of claim 1, wherein the data collection unit includes a complier to scan the protected data resources.

3. The database system of claim 1, wherein the advisory module further comprises
an analysis unit coupled to the data collection unit and configured to categorize the data collected by the data collection unit into a scan record.

4. The database system of claim 3, wherein the advisory module further comprises
an evaluation unit coupled to the analysis unit and configured to evaluate the scan record to identify a client finding associated with the management of the protected data resources.

5. The database system of claim 4, wherein the evaluation unit is configured to compare the scan record to an issue profile to identify the client finding.

6. The database system of claim 5, wherein the advisory module further comprises
a recommendation unit coupled to the evaluation unit and configured to generate the advisory based on the client finding.

7. The database system of claim 6, wherein the recommendation unit is configured to generate the advisory as a message to the client.

8. The database system of claim 6, wherein the recommendation unit is configured to generate the advisory as a procurement request.

9. The database system of claim 6, wherein the recommendation unit is configured to generate the advisory as a vendor recommendation.

10. The system of claim 1, wherein the database is a multi-tenant database system.

11. A computer-implemented method of managing protected data resources of a client, the method comprising:
scanning the protected data resources of the client with a data collection unit;
evaluating the scanned protected data resources to identify a client finding with an evaluation unit;
generating an advisory based on the client finding with a recommendation unit; and
sending the advisory to the client.

12. The method of claim 11, wherein the scanning step includes
scanning source code associated with the protected data resources with a compiler.

13. The method of claim 11, wherein the generating step includes generating a message for the client.

14. The method of claim 11, wherein the generating step includes generating a procurement request.

15. The method of claim 14, further comprising sending the procurement request to a procurement system.

16. The method of claim 11, wherein the scanning step includes scanning the protected data resources in a multitenant database system.

17. A system comprising a processor and a memory, wherein the memory comprises computer-executable instructions that, when executed by the processor, cause the system to:
scan a protected data resources of a client in a multi-tenant database system with a data collection unit;
evaluate the scanned protected data resources to identify a client finding with an evaluation unit;
generate an advisory based on the client finding with a recommendation unit; and
send the advisory to the client.

18. The system of claim 17, wherein the computer-executable instructions, when executed by the processor, further cause the system to
scan source code associated with the protected data resources with a compiler.

19. The system of claim 17, wherein the computer-executable instructions, when executed by the processor, further cause the system to
generate a message for the client.

20. The system of claim 17, wherein the computer-executable instructions, when executed by the processor, further cause the system to
generate a procurement request.
